(19) United States
(12) Patent Application Publication
(10) Pub. No.: US 2026/0356592 A1
(43) Pub. Date: Nov. 12, 2026

(54) SEPARATING DEVICE

(71) Applicant: M. TANNER AG, Winterthur (CH)

(72) Inventors: Marco TANNER, Bassersdorf (CH); Marcel TANNER, Bassersdorf (CH)

(73) Assignee: M. TANNER AG, Winterthur (CH)

(21) Appl. No.: 19/135,416

(22) PCT Filed: Dec. 6, 2023
(86) PCT No.: PCT/EP2023/084421

§ 371 Date: Jun. 4, 2025

(30) Foreign Application Priority Data
Dec. 6, 2022 (CH) CH001558/2022

(51) Int. Cl. B65G 21/20

(52) U.S. Cl. CPC B65G 21/2072; B65G 2201/0247; B65G 2207/00

(57) ABSTRACT

A separating device for separating piece goods, in particular preforms, which have a supporting ring, is described, including two guide elements arranged in parallel and spaced apart from one another, a linear conveying path for the preforms being formed between the guide elements, in which conveying path the preforms can be conveyed upright in individual rows, in that the preforms are each suspended by the support ring from the guide elements, the separating device having a housing in which the guide elements are arranged, and the housing having at least one access door which is arranged on a side wall of the housing and is designed to provide access to an interior of the housing.

### FIELD OF THE INVENTION

The present invention relates to a separating device for separating piece goods, in particular preforms, which have a Supporting ring.

### BACKGROUND OF THE INVENTION

Plastic containers, such as PET bottles, are often produced from preforms by blow molding in a blow molding machine or stretch blow molding machine. The preforms are usually delivered unordered as piece goods in large containers and conveyed to a separating unit via a loading device.

In the separating device, the preforms arriving unordered can be separated and conveyed further. For example, the separating device straightens up the preforms and forms a single row of preforms, which leave the separating device, for example via a downward sloping discharge rail. From there, the preforms can pass via further feeding devices and/or testing devices to a stretch blow molding machine, where their cylindrical body is blown into the desired bottle shape. The preforms typically have a threaded head with a threaded connection piece and a collar or support ring at one open end, which has a larger diameter than the rest of the cylindrical body of the preform.

Such a separating device is described, for example, in WO 2010/006461A1. The separating device has a pair of guide elements arranged in parallel, between which the cylindrical bodies can be erected by hanging the cylindrical bodies with the projection on the guide elements, i.e. with the second end pointing downwards. The cylindrical bodies form a single row along the guide elements and can thus be guided to a discharge for conveying the cylindrical bodies further. The separating device has a height guide arranged above the individual row, whereby a distance between the height guide and the cylindrical bodies, viewed in the conveying direction, is reduced to a predetermined distance from the guide elements, whereby vertically protruding cylindrical bodies are pressed down or guided by the height guide as they are conveyed in the conveying direction. The height guide can be raised briefly by means of a lifting device in accordance with a trigger signal.

### SUMMARY OF THE INVENTION

Due to the high conveying capacity of such separating devices, failures in the conveying of preforms in the separating device can lead to downtimes of the downstream system and operational interruptions with corresponding consequential costs. If malfunctions occur, it is therefore desirable to provide easy repairability, in particular through simple and safe access to the separating device. Faults can be caused, for example, by preforms which rest with the collar on a collar of an adjacent preform and/or preforms which do not rest in the desired orientation in the separating device, resulting in a jam of preforms. In order to rectify such and other faults and/or make adjustments to the settings of the separating device, it is typically necessary to gain access to the separating device, e.g. in order to release wedged preforms.

It is therefore an object of the present invention to provide a separating device for separating piece goods, in particular preforms, which at least partially improves the state of the art.

This object is achieved by a separating device with the features of the independent claims. Advantageous embodiments of the invention are given in the dependent claims and in the present description and figures.

The invention relates to a separating device for the separation of piece goods, in particular preforms, which have a supporting ring, comprising two guide elements arranged in parallel and spaced apart from one another, wherein a linear conveying path for the preforms is formed between the guide elements, in which conveying path the preforms can be conveyed upright in a single row, in that the preforms are each suspended by the support ring at the guide elements, wherein the separating device has a housing in which the guide elements are arranged, and wherein the housing has at least one access door which is arranged on a side wall of the housing and is designed to provide access to an interior of the housing.

The housing can provide protection from external influences for the piece goods conveyed in the separating device, in particular preforms. However, in the event of faults, e.g. if the piece goods being conveyed in the separating device, such as preforms, become wedged, during maintenance, adjustments, etc., it may be necessary to gain access to the housing in order to rectify the fault or change settings as efficiently as possible. As the fault is typically rectified manually by an operator, it is particularly advantageous if accessibility is simplified for the operator. Also, changes to settings can be made manually, for which easy and safe access to the inside of the housing is advantageous. By arranging the at least one access door on a side wall of the housing, simplified and also safe access to the inside of the housing can be provided. An operator can then approach the separating device from the side and open the door from the side in order to rectify a fault inside the separating device or to be able to make adjustments.

Compared to prior art solutions, in which access into the housing is provided through an access door on the ceiling wall of the housing, i.e. from above, this simplifies access and also improves safety by allowing the operator to operate at a lower height. Furthermore, compared to known access solutions on the ceiling wall, a platform with a staircase arranged on the housing, on which an operator must first climb in order to reach a sufficient height for access from above the housing, can be dispensed with, by which safety can be improved. Due to the fall height with a raised platform, known prior art solutions also typically require a railing to be arranged on the stairs and on the platform. By reducing the operating height, the separating device disclosed here can also advantageously dispense with a railing.

In certain embodiments, the at least one access door may form a side wall of the housing or at least part of a side wall of the housing.

The separating device disclosed herein is particularly advantageous for linear separating devices, i.e. with linear or straight conveyor sections. The piece goods preferably have a body and a support ring arranged on the body. The body of the piece goods can have a cup-like shape. The preforms typically have a cylindrical body and a support ring attached to the cylindrical body as well as a thread.

In an embodiment, the conveyor section has a gradient of between 10° and 30°, preferably between 15° and 25°. The incline allows gravity to be used for conveying the piece goods, in particular the preforms, in the separating device.

In an embodiment, the at least one access door can be hinged open in a direction perpendicular to the conveyor line.

The at least one access door is preferably mounted on the side wall via at least one hinge and can therefore be hinged upwards or downwards. The fact that it can be opened perpendicular to the conveyor line means that the space required in the direction parallel to the conveyor line due to the at least one access door can be optimized or kept small.

If there are several access doors, all access doors can, in an embodiment, be hinged upwards or all access doors can be hinged downwards. However, it is also conceivable that, in an embodiment, one or more of the access doors can be hinged upwards and one or more of the access doors can be hinged downwards.

In an embodiment, the separating device has at least one holding device which is configured in each case to hold the at least one hinged access door in an opened position.

By holding the at least one hinged access door in an open position, the safety and/or operability for the operator can be improved when rectifying the fault and/or adjusting settings, since, for example, the operator does not have to hold the access door open and/or it can be avoided that the access door closes at an undesired moment during the rectification of the fault and/or the adjustment of a setting.

In an embodiment, the holding device has a switchable electromagnet or a permanent magnet with which the at least one hinged access door can be held magnetically in the opened position.

The holding device can be easily activated and deactivated using a switchable electromagnet. Alternatively, a permanent magnet can be used to provide a simple holding device that does not require a separate power supply and control unit.

In an embodiment, the holding device has a latching device into which a projection or a recess of the at least one access door can be latched in the opened position.

In an embodiment, the holding device has a locking device which is designed to hold the at least one hinged access door in the opened position.

The locking device preferably has a bolt that can engage in a counterpart. The bolt or the counterpart can be arranged on the access door. The locking device can have an electrically or manually operated bolt. The locking device can have a pivoting or sliding bolt. The locking device can have a lock with which the bolt can be locked in the locked position. An operator can therefore operate the lock with a key, for example, in order to release the holding device again, i.e. to close the hinged access door again.

In an embodiment, the at least one access door can be hinged open in a direction opposite to gravity in such a way that the access door can be held in a closed position by gravity.

The access door can therefore be folded upwards in relation to the floor on which the separating device stands. Due to the fact that the at least one access door can be held in a closed position by gravity, it can advantageously be achieved without additional specific precautions that the basic position of the at least one access door is the closed position, so that undesired or unintentional access to the interior of the separating device can be prevented or made more difficult.

In an embodiment, the at least one access door can be pivoted by at least 180°, preferably by at least 200°, particularly preferably by at least 260°, when opened.

By pivoting by at least 180°, preferably by at least 200°, particularly preferably by at least 260°, a wide opening of the at least one access door can be provided, which simplifies the rectification of faults and/or the adjustment of settings inside the housing.

In an embodiment, the at least one access door is mounted on the side wall via at least one hinge, with the at least one hinge having a hinge switch.

The hinge switch makes it possible in a simple manner to use the hinge to switch certain processes of the separating device and/or a conveyor system comprising the separating device. One or more operations of the separating device and/or of a conveyor system comprising the separating device can therefore be triggered or switched by opening and/or closing the at least one access door.

In an embodiment, the separating device has a control unit which is connected to the hinge switch and is configured to stop the separating device when the hinge switch is switched.

The feature that the control unit stops the separating device when the hinge switch is switched can increase safety, since it can be ensured that the separating device is stopped while the operator has access to the interior of the separating device or the housing and rectifies a fault and/or changes a setting. The hinge switch is therefore preferably set up to switch when the at least one access door is opened, so that the control unit can stop the separating device when the at least one access door is opened. When the at least one access door is closed, the hinge switch can switch back again so that the control unit can put the separating device back into operation.

In an embodiment, the at least one access door is designed as a sliding door that can be moved along the side wall.

A sliding door design offers the advantage that the space required for opening the at least one access door can be optimized or reduced. Preferably, the at least one access door can be moved in a direction parallel to the conveyor line. An access door that can be displaced in a direction parallel to the conveyor line also offers the advantage that the access door can be designed in such a way that the access door can be stationary in an open position even without a specific holding device. However, even with a displaceable access door, the separating device can have a holding device as disclosed for a hinged access door.

In an embodiment, the at least one access door is arranged on an inclined side wall and is preferably flush with the inclined side wall in a closed position.

The housing can, for example, have an upper ceiling wall, which is horizontal in relation to the conveying path, and two side walls adjoining the ceiling wall, which are inclined at an angle to the ceiling wall. The angle of inclination can, for example, be between 20° and 75° or between 30° and 60°. With an arrangement of the at least one access door on an inclined side wall, in addition to simplified access for an operator from the side, at least partial access from above can also be provided. It is therefore possible to combine the advantage of an improved operating height by arranging the at least one access door on a side wall with accessibility from above for rectifying faults and/or adjusting settings.

The space required for at least one access door can be reduced thanks to the flush design.

In certain embodiments, the at least one access door can form an inclined side wall or at least part of an inclined side wall.

In an embodiment, the at least one access door is arranged on a vertical side wall and is preferably flush with the vertical side wall in a closed position.

The operating height can be further reduced by arranging the access door on a vertical side wall.

In certain embodiments, the at least one access door can form a vertical side wall or at least part of a vertical side wall.

In an embodiment, the separating device has at least one locking device which is designed to lock the at least one access door in a closed position.

This can prevent unintentional or unwanted opening of the access door, which can increase security. The locking device can operate with a bolt, a latching device or magnetically.

In an embodiment, the separating device has a plurality of access doors arranged along the conveying path.

This offers the advantage that an operator can open the housing specifically at the position along the conveying path where a fault occurs and/or where a setting needs to be adjusted.

In an embodiment, the separating device has an access door that extends over at least a major portion of the conveying path.

This offers the advantage of a simple construction of the housing and the separating device and furthermore a simple operability of the separating device.

In one embodiment, the separating device has exactly one access door, which extends over at least a major portion of the conveyor section.

In an embodiment, the at least one access door comprises a window.

A window offers the advantage that an operator can see into the interior of the housing through the access door and can recognize whether and where a fault occurs. Preferably, the window extends over a major portion of the access door, so that an operator can advantageously have a view of the entire or almost the entire conveying path in the separating device.

In an embodiment, the separating device has at least one access door, which is arranged on a horizontal ceiling wall of the housing in relation to the conveying path.

This allows a side access door to be combined with an upper access door. It is also possible to supplement a housing with an upper access door with a side access door or to add a side access door. In certain embodiments, the upper access door can at least partially form a horizontal ceiling wall of the housing.

In an embodiment, the guide elements comprise counter-rotating, spaced-apart rollers.

The preforms can therefore be erected between the rollers and the cylindrical bodies of the preforms can be conveyed in a single row in the space between the rollers. Other guide elements are also conceivable, for example comprising rails or belts.

In an embodiment, the separating device has a fault detection sensor, in particular a wedging sensor, which is configured to detect a fault, in particular a wedging of preforms. The fault detection sensor can comprise a camera or one or more light barriers. The fault detection sensor can be configured to send a signal to an alarm device in the event of a fault, which brings the fault to the attention of an operator. The operator can then open an access door of the separating device in order to rectify the fault.

In an embodiment, the separating device has a step-free, preferably railing-free, access area, which is arranged to the side of the at least one access door.

As explained, access for an operator can therefore be simplified, as the operator does not have to climb any steps in order to rectify a fault inside the separating device and/or adjust a setting. In addition, safety is increased as the operator can operate at floor level or close to the floor. This allows the operator to keep his hands free, for example, and to operate more safely with tools, for example. Preferably, the at least one access door is arranged on the side wall of the housing facing the access area.

In an embodiment, the separating device has an access platform, preferably single-stage, which is arranged to the side of the at least one access door and which is preferably free of railings.

The access platform can provide improved access to the interior of the housing, whereby the access platform, e.g. via a single step, can be designed lower, in particular near the floor, due to the arrangement of the at least one access door on a side wall of the separating device, compared to the known platforms, which improves safety and accessibility for an operator.

In particular, the access platform can have a height of less than 1 m, preferably less than 0.5 m.

In an embodiment, an operating device, preferably comprising a push panel or a touch panel, is arranged on the side of the housing at a height below an upper end of the housing.

This can also make it easier for an operator to access the operating device. The separating device can be controlled via the operating device. Furthermore, an operator can simultaneously view the interior of the separating device and operate the operating device from near the floor. The operator can therefore operate the separating device from near the floor or standing on the floor while monitoring the flow of the piece goods in the separating device. In the context of the present disclosure, the term “above” shall be understood in relation to the floor on which the separating device stands, i.e. as shown in the figures.

The invention further relates to a conveyor system for preforms comprising a separating device according to the present disclosure and a feed device which is arranged downstream of the separating device, wherein the feed device has a feed conveying path for the preforms which is horizontal or has a gradient of between 1° and 20°, preferably between 5° and 10°, relative to the horizontal in the conveying direction.

The low gradient of the feed conveying path of the feed device means that the feed device can be installed close to the floor. This also makes it possible to reduce the height of the separating device, which has an advantageous effect on the operating height of the separating device, as explained above.

The invention further relates to a separating device for the separation of piece goods, in particular preforms, which have a support ring, comprising two guide elements arranged in parallel and spaced apart from one another, linear conveying path for the preforms being formed between the guide elements, in which the preforms can be conveyed upright in a single row, in that the preforms are each suspended by the support ring at the guide elements, the separating device having a housing in which the guide elements are arranged, and the housing having at least one access door which is designed to provide access to an interior of the housing, wherein the separating device has a step-free, preferably railing-free, access area which is arranged to the side of the housing.

With the step-free, preferably railing-free access area, access for an operator can be simplified, as the operator does not have to climb any steps to rectify a fault inside the separating device and/or adjust a setting. Safety is also increased as the operator can operate at floor level or close to the floor. This allows the operator to keep their hands free and operate more safely with tools, for example.

The invention further relates to a conveyor system for preforms comprising a separating device according to the present disclosure and a feed device which is arranged downstream of the separating device, wherein the feed device has a feed conveying path for the preforms which has an incline relative to the horizontal in the conveying direction.

By the feature of the feed device arranged downstream to the separating device having an incline, the height of the separating device can be reduced or the separating device can be installed at a lower height so that an operator can operate the separating device close to the ground.

In one embodiment of the conveyor system, the incline is between 5° and 20°, preferably between 10° and 15°.

### LIST OF FIGURES

Exemplary embodiments of the invention are explained in more detail with reference to the following figures and the associated description. They show schematically:

FIG. 1 A perspective view of a part of a conveyor system with an embodiment of a separating device;

FIG. 2 an enlarged view of the separating device from FIG. 1;

FIG. 3 a side view of the separating device from FIG. 1;

FIG. 4 A perspective view of an embodiment of a separating device with an open access door.

### DESCRIPTION OF EXEMPLARY EMBODIMENTS

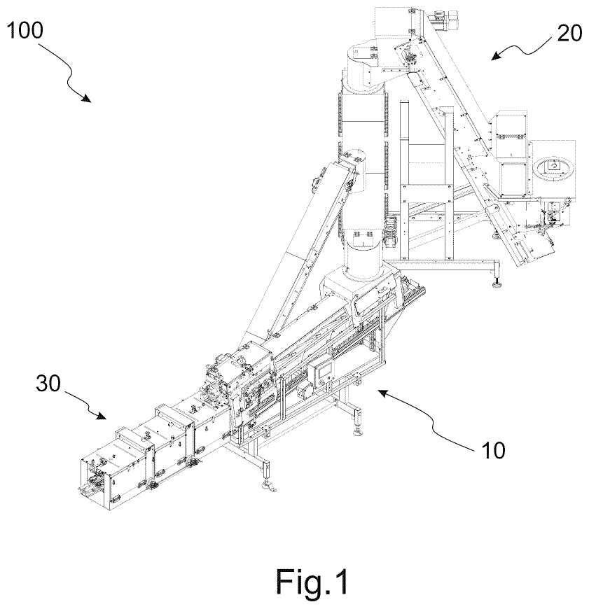

FIG. 1 shows a perspective view of a part of a conveyor system 100 with an embodiment of a separating device 10, which is arranged between a high conveyor 20 and a feed device 30. The separating device 10 is designed for separating preforms, which have a support ring, and comprises two rollers arranged in parallel, spaced apart and rotatable in opposite directions. The separating device 10 is arranged downstream of the high conveyor 20. The disordered preforms arriving from the high conveyor 20 can be separated upright in a single row in the separating device 10, which is designed as a roller sorter. Downstream of the separating device 10 is the feed device 30, which receives the correctly aligned, ordered preforms from the separating device 10. The conveyor system 100 can also include a clamping conveyor with an infeed starwheel, which receives the preforms from the feed device 30. From the clamping conveyor, the preforms can reach a stretch blow molding machine via a discharge rail, for example. The feed device 30 can also feed the preforms directly to a stretch blow molder or to its infeed starwheel.

The feed device 10 can be designed as disclosed in document WO2022/223734 A1. The corresponding disclosure is deemed to be incorporated into the present disclosure by reference. In particular, the feed device has a feed conveyor section with a gradient of between 1° and 20°.

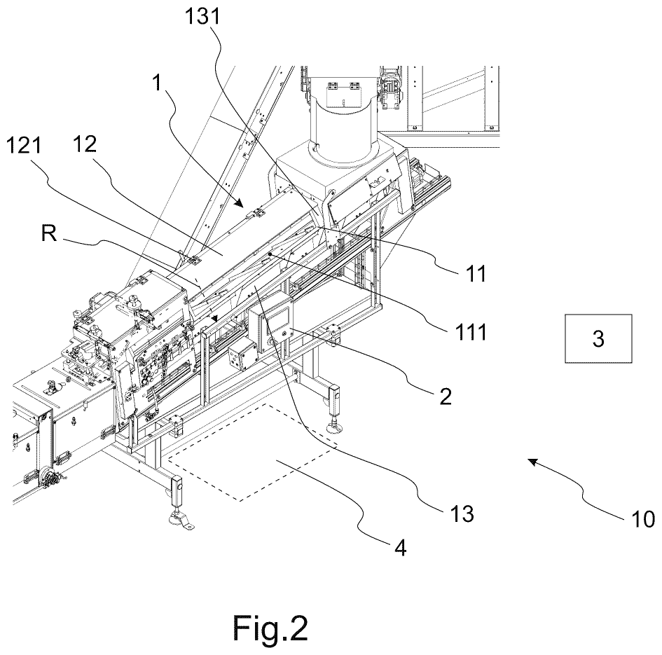

FIG. 2 shows an enlarged view of the separating device 10 from FIG. 1. The separating device 10 has a housing 1 in which the guide elements in the form of rollers are arranged. The housing 1 has an access door 11 extending along the linear conveyor section formed between the rollers, which is arranged on a side wall 13, or on an inclined side wall 131, of the housing 1 or forms an inclined side wall of the housing 1. In certain embodiments, the housing can have a plurality of access doors, which are arranged along the linear conveying path.

The access door 11 is mounted on the housing 1 via hinges and can be opened downwards in the direction R perpendicular to the conveyor line. The direction R is indicated by a dashed arrow. One of the hinges has a hinge switch, which is set up to switch when the access door 11 is opened. The separating device 10 has a control unit 3, which is connected to the hinge switch and is configured to stop the separating device 10 when the hinge switch is switched.

The separating device 10 has a holding device designed as a locking device, which is configured to hold the access door 11 in the opened position.

The access door 11 also has a window 111, which extends over a major portion of the access door 11. Through the window 111, an operator can have a view of almost the entire conveying path inside the housing 1.

The housing 1 also has an upper access door 12, which forms a horizontal ceiling wall of the housing 1 in relation to the conveying path. The upper access door 12 is mounted on the housing 1 via hinges 121. The hinges of the side access door 11, which are not visible in FIG. 2, essentially correspond in structure to the hinges 121.

In the closed position shown, the access door 11 is inclined by an angle of 60° relative to the upper access door 12 in its closed position.

A step-free and railing-free access area 4 is arranged to the side of the access door 11, via which an operator can gain step-free access to the access door 11 and operate the Separating device 10.

The separating device 10 also has an operating device 2 with a touch panel. The control panel 2 is arranged on the side of the housing 1 at a height below the upper end of the housing 1. The operating device 2 can also be reached via the step-free access area 4. An operator can operate the operating device 2 while standing on the floor in the access area 4 and at the same time monitor the conveying flow in the housing 1 via the window 111. In certain embodiments, the operating device 2 can comprise the control unit 3 or the control unit 3 can be integrated in the operating device 2.

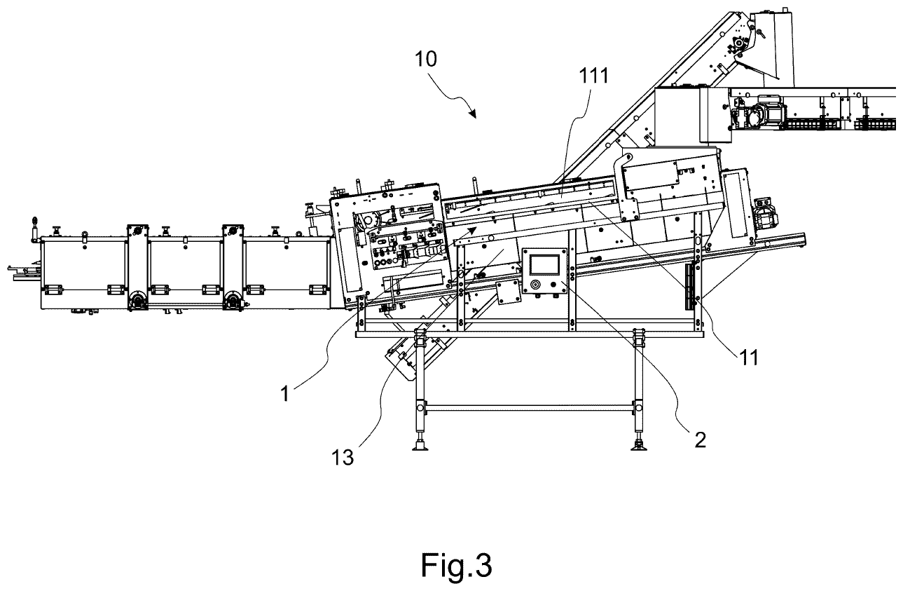

FIG. 3 shows a side view of the separating device 10 from FIG. 1. The side access door 11 of the housing 1 is shown in the closed position. Through the window 111, an operator can see into the interior of the housing 1 and simultaneously operate the separating device 10 with the operating device 2.

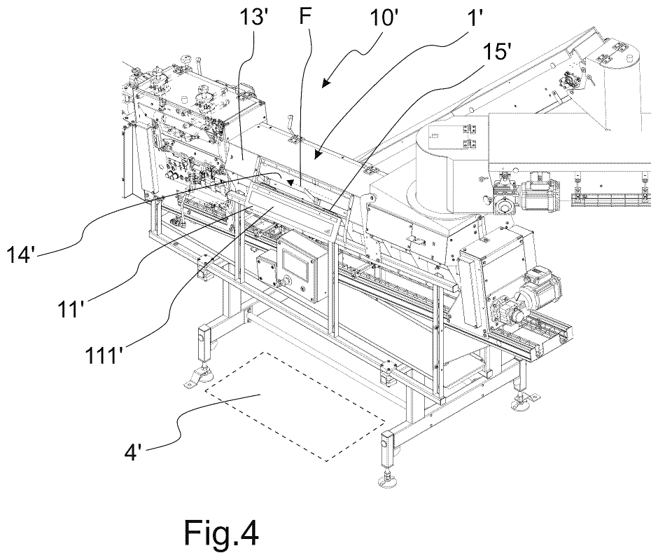

FIG. 4 shows a perspective view of an embodiment of a separating device 10′. The housing 1′ comprises an access door 11′ that can be opened downwards in a direction perpendicular to the conveying path F, which is mounted on the side wall 13′ or the housing 1′ via two hinges 15′. The conveyor section F is indicated by a dashed arrow. One of the hinges 15′ has a hinge switch, which is connected to a control unit that is configured to stop the separating device 10′ when the hinge switch is switched. The hinge switch is configured to switch when the access door 11′ is opened.

The access door 11′ is arranged on an inclined side wall 13′ of the housing 1′ and is flush with the inclined side wall 13′ in a closed position. In FIG. 4, the access door 11′ is shown in an open or swung-open position, whereby the access door 11′ is swung open by 180° relative to the closed position. The access door 11′ extends over a major portion of the conveying path of the separating device 10′ and is arranged on the side wall 13′ of the housing 1′ facing the access area 4′.

The access door 11′ has a window 111′ which extends over a major portion of the access door 11′ and through which an operator can obtain a view of the interior 14′ of the housing 15′ when the access door 11′ is in the closed position.

1. A separating device for separating piece goods, which have a supporting ring, comprising two guide elements arranged in parallel and spaced apart from one another, wherein a linear conveying path for the preforms is formed between the guide elements, in which conveying path the preforms can be conveyed upright in a single row, in that the preforms are each suspended by the support ring at the guide elements, wherein the separating device has a housing in which the guide elements are arranged, and wherein the housing has at least one access door which is arranged on a side wall of the housing and is designed to provide access to an interior of the housing.

2. The separating device according to claim 1, wherein the at least one access door can be hinged open in a direction perpendicular to the conveyor section.

3. The separating device according to claim 2, wherein the separating device has at least one holding device which is configured in each case to hold the at least one hinged access door in an opened position.

4. The separating device according to claim 3, wherein the holding device has a switchable electromagnet or a permanent magnet, with which the at least one hinged access door can be held magnetically in the opened position.

5. The separating device according to claim 3, wherein the holding device has a latching device into which a projection or a recess of the at least one access door can be latched in the opened position, or has a locking device which is configured to hold the at least one hinged access door in the opened position.

6. The separating device according to claim 2, wherein the at least one access door can be opened in a direction opposite to the force of gravity in such a way that the access door can be held in a closed position by the force of gravity.

7. The separating device according to claim 1, wherein the at least one access door can be pivoted by at least 180° when it is opened.

8. The separating device according to claim 1, wherein the at least one access door is mounted on the side wall via at least one hinge, the at least one hinge having a hinge switch.

9. The separating device according to claim 8, wherein the separating device has a control unit which is connected to the hinge switch and is configured to stop the separating device when the hinge switch is switched.

10. The separating device according to claim 1, wherein the at least one access door is designed as a sliding door displaceable along the side wall.

11. The separating device according to claim 1, wherein the at least one access door is arranged on an inclined side wall and is flush with the inclined side wall in a closed position.

12. The separating device according to claim 1, wherein the at least one access door is arranged on a vertical side wall and is flush with the vertical side wall in a closed position.

13. The separating device according to claim 1, wherein the separating device has at least one locking device which is configured to lock the at least one access door in a closed position.

14. The separating device according to claim 1, wherein the separating device has a plurality of access doors which are arranged along the conveying path.

15. The separating device according to claim 1, wherein the separating device has an access door which extends over at least a major portion of the conveying path.

16. The separating device according to one claim 1, wherein the at least one access door comprises a window.

17.-18. (canceled)

19. The separating device according to claim 1, wherein the separating device has a step-free, access area, which is arranged to the side of the at least one access door.

20. The separating device according to claim 1, wherein the separating device has an access platform, which is arranged to the side of the at least one access door.

21.-22. (canceled)

23. A conveying system for preforms, comprising a separating device according to claim 1 and a feed device which is arranged downstream of the separating device, the feed device having a feed conveying path for the preforms which is horizontal or has a gradient of between 1° and 20°, in the conveying direction with respect to the horizontal.

24. The separating device for the separation of piece goods, which have a supporting ring, comprising two guide elements arranged in parallel and spaced apart from one another, a linear conveying path for the preforms being formed between the guide elements, in which conveying path the preforms can be conveyed upright in a single row, in that the preforms are suspended in each case with the supporting ring at the guide elements, wherein the separating device has a housing in which the guide elements are arranged, and the housing has at least one access door which is arranged to provide access to an interior of the housing, wherein the separating device has a step-free, access area which is arranged at the side of the housing.

25.-27. (canceled)
